(19) United States
(12) Patent Application Publication
(10) Pub. No.: US 2020/0410498 A1
(43) Pub. Date: Dec. 31, 2020

(54) Method, System, and Computer Program Product for Automatically Generating a Suggested Fraud Rule for an Issuer

(71) Applicant: Visa International Service Association, San Francisco, CA (US)

(72) Inventors: Youxing Qu, Austin, TX (US); Yiwei Cai, Austin, TX (US); Hangqi Zhao, Seattle, WA (US); Raj Parekh, Cerritos, CA (US); Anurag Tangri, Burlingame, CA (US); Harishkumar Sundarji Majithiya, Austin, TX (US); Roshni Ann Samuel, Cedar Park, TX (US)

(21) Appl. No.: 16/906,177

(22) Filed: Jun. 19, 2020

Related U.S. Application Data
(60) Provisional application No. 62/866,734, filed on Jun. 26, 2019.

(51) Int. Cl. G06Q 20/40; G06N 20/00

(52) U.S. Cl. CPC G06Q 20/4016; G06N 20/00; G06Q 20/4015

(57) ABSTRACT

A method for automatically generating a suggested fraud rule for an issuer includes: identifying a first issuer from a plurality of issuers; determining a transaction volume category and a region category associated with the first issuer; determining a second issuer from the plurality of issuers associated with the same transaction volume category and region category; associating the first issuer and the second issuer to form an issuer consortium; obtaining consortium transaction data associated with the issuer consortium; generating a suggested fraud rule for the first issuer based on the consortium transaction data; and communicating the suggested fraud rule to a first issuer system associated with the first issuer.

### CROSS REFERENCE TO RELATED APPLICATION

This application claims priority to U.S. Provisional Patent Application No. 62/866,734, filed Jun. 26, 2019, the disclosure of which is incorporated herein by reference in its entirety.

### BACKGROUND

### 1. Technical Field

The present disclosure relates to methods, systems, and computer program products for automatically generating a suggested fraud rule for an issuer.

### 2. Technical Considerations

Techniques have been developed to monitor electronic payment transactions and identify fraudulent transactions before, or soon after, such transactions are initiated. To better identify these fraudulent transactions, fraud rules were developed to automatically detect fraudulent activity. For example, fraud rules may be used to determine if a payment transaction is fraudulent or if a payment account has been compromised. These rules may be evaluated by payment account issuers, various devices associated with payment processing networks, and/or merchant acquirers. Once a transaction is identified as fraudulent, the transaction may be immediately rejected, flagged for manual approval, and/or approved and logged for later review.

However, existing systems fail to adequately help certain issuers monitor transactions and identify fraudulent transactions. For example, small issuers (e.g., issuers handling <15,000 electronic transactions per day) do not have a sufficient volume of transaction data to enable useful fraud rules to be developed for that issuer. Moreover, existing systems fail to consider how certain segments of issuers (e.g., issuers in different geographic regions or having a different size) encounter different types of fraudulent activity requiring different fraud rules. For example, the type of fraudulent activity associated with electronic payment transactions in one region (e.g., the United States or New York City) may vary significantly from the type of fraudulent activity associated with electronic payment transactions in another region (e.g., Australia or Melbourne). As another example, the type of fraudulent activity associated with electronic payment transactions facing one size of the issuer (e.g., small issuers) may vary significantly from the type of fraudulent activity associated with electronic payment transactions facing another size of issuer (e.g., large issuers handling >100,000 electronic transactions per day).

### SUMMARY

According to some non-limiting embodiments or aspects, a method for automatically generating a suggested fraud rule for an issuer includes: identifying, with at least one processor, a first issuer from a plurality of issuers; determining, with at least one processor, a transaction volume category and a region category associated with the first issuer; determining, with at least one processor, at least one second issuer from the plurality of issuers, where each of the at least one second issuer is associated with the same transaction volume category and region category as the first issuer; associating, with at least one processor, the first issuer and the at least one second issuer to form an issuer consortium; obtaining, with at least one processor, consortium transaction data associated with the issuer consortium, where the consortium transaction data includes transaction data associated with the first issuer and transaction data associated with the at least one second issuer; generating, with at least one processor, at least one suggested fraud rule for the first issuer based on the consortium transaction data; and communicating, with at least one processor, the at least one suggested fraud rule to a first issuer system associated with the first issuer.

In some non-limiting embodiments or aspects, generating the at least one suggested fraud rule may include analyzing, with at least one processor, the consortium transaction data using a machine learning algorithm. The method may further include segmenting, with at least one processor, the consortium transaction data based on at least one attribute. The at least one suggested fraud rule for the first issuer may be generated based on the segmented consortium transaction data. The at least one attribute may include transaction type. The at least one attribute may include at least one data element defined by ISO 8583. The transaction volume category may include only issuers conducting an average of fewer than 15,000 electronic payment transactions per day. The region category may include only issuers having transaction data in a predetermined country or geographic region, where the consortium transaction data may include only transaction data associated with electronic payment transactions initiated in the predetermined country or geographic region. Communicating the at least one suggested fraud rule to a first issuer system may include communicating effectiveness data associated with the at least one suggested fraud rule. The method may include filtering, with at least one processor, the consortium transaction data, such that the first issuer system does not receive the transaction data associated with the at least one second issuer.

According to some non-limiting embodiments or aspects, a system for automatically generating a suggested fraud rule for an issuer includes at least one processor programmed or configured to: identify the first issuer from a plurality of issuers; determine a transaction volume category and a region category associated with the first issuer; determine at least one second issuer from the plurality of issuers, where each of the at least one second issuer is associated with the same transaction volume category and region category as the first issuer; associate the first issuer and the at least one second issuer to form an issuer consortium; obtain consortium transaction data associated with the issuer consortium, where the consortium transaction data includes transaction data associated with the first issuer and transaction data associated with the at least one second issuer; generate at least one suggested fraud rule for the first issuer based on the consortium transaction data; and communicate the at least one suggested fraud rule to a first issuer system associated with the first issuer.

In some non-limiting embodiments or aspects, generating the at least one suggested fraud rule may include analyzing the consortium transaction data using a machine learning algorithm. The at least one processor may be further programmed or configured to segment the consortium transaction data based on at least one attribute. The at least one suggested fraud rule for the first issuer may be generated based on the segmented consortium transaction data. The at least one attribute may include transaction type. The at least one attribute may include at least one data element defined by ISO 8583. The transaction volume category may include only issuers conducting an average of fewer than 15,000 electronic transactions per day. The region category may include only issuers having transaction data in a predetermined country or geographic region, where the consortium transaction data may include only transaction data associated with electronic transactions initiated in the predetermined country or geographic region. Communicating the at least one suggested fraud rule to a first issuer system may include communicating effectiveness data associated with the at least one suggested fraud rule. The at least one processor may be further programmed or configured to filter the consortium transaction data such that the first issuer system does not receive the transaction data associated with the at least one second issuer.

According to some non-limiting embodiments or aspects, a computer program product for automatically generating a suggested fraud rule for an issuer includes at least one non-transitory computer-readable medium including one or more instructions that, when executed by at least one processor, cause the at least one processor to: identify a first issuer from a plurality of issuers; determine a transaction volume category and a region category associated with the first issuer; determine at least one second issuer from the plurality of issuers, where each of the at least one second issuer is associated with the same transaction volume category and region category as the first issuer; associate the first issuer and the at least one second issuer to form an issuer consortium; obtain consortium transaction data associated with the issuer consortium, where the consortium transaction data includes transaction data associated with the first issuer and transaction data associated with the at least one second issuer; generate at least one suggested fraud rule for the first issuer based on the consortium transaction data; and communicate the at least one suggested fraud rule to a first issuer system associated with the first issuer.

In some non-limiting embodiments or aspects, generating the at least one suggested fraud rule may include analyzing the consortium transaction data using a machine learning algorithm. The one or more instructions may cause the at least one processor to segment the consortium transaction data based on at least one attribute. The at least one suggested fraud rule for the first issuer may be generated based on the segmented consortium transaction data. The at least one attribute may include transaction type. The at least one attribute may include at least one data element defined by ISO 8583. The transaction volume category may include only issuers conducting an average of fewer than 15,000 electronic transactions per day. The region category may include only issuers having transaction data in a predetermined country or geographic region, where the consortium transaction data may include only transaction data associated with electronic transactions initiated in the predetermined country or geographic region. Communicating the at least one suggested fraud rule to a first issuer system may include communicating effectiveness data associated with the at least one suggested fraud rule. The one or more instructions may cause the at least one processor to filter the consortium transaction data such that the first issuer system does not receive the transaction data associated with the at least one second issuer.

Further non-limiting embodiments or aspects are set forth in the following numbered clauses:

Clause 1: A method for automatically generating a suggested fraud rule for an issuer, comprising: identifying, with at least one processor, a first issuer from a plurality of issuers; determining, with at least one processor, a transaction volume category and a region category associated with the first issuer; determining, with at least one processor, at least one second issuer from the plurality of issuers, wherein each of the at least one second issuers is associated with the same transaction volume category and region category as the first issuer; associating, with at least one processor, the first issuer and the at least one second issuer to form an issuer consortium; obtaining, with at least one processor, consortium transaction data associated with the issuer consortium, wherein the consortium transaction data comprises transaction data associated with the first issuer and transaction data associated with the at least one second issuer; generating, with at least one processor, at least one suggested fraud rule for the first issuer based on the consortium transaction data; and communicating, with at least one processor, the at least one suggested fraud rule to a first issuer system associated with the first issuer.

Clause 2: The method of clause 1, wherein generating the at least one suggested fraud rule comprises analyzing, with at least one processor, the consortium transaction data using a machine learning algorithm.

Clause 3: The method of clause 1 or 2, further comprising: segmenting, with at least one processor, the consortium transaction data based on at least one attribute.

Clause 4: The method of any of clauses 1-3, wherein the at least one suggested fraud rule for the first issuer is generated based on the segmented consortium transaction data.

Clause 5: The method of any of clauses 1-4, wherein the at least one attribute comprises transaction type.

Clause 6: The method of any of clauses 1-5, wherein the at least one attribute comprises at least one data element defined by ISO 8583.

Clause 7: The method of any of clauses 1-6, wherein the transaction volume category comprises only issuers conducting an average of fewer than 15,000 electronic payment transactions per day.

Clause 8: The method of any of clauses 1-7, wherein the region category comprises only issuers having transaction data in a predetermined country or geographic region, wherein the consortium transaction data comprises only transaction data associated with electronic payment transactions initiated in the predetermined country or geographic region.

Clause 9: The method of any of clauses 1-8, wherein communicating the at least one suggested fraud rule to a first issuer system comprises communicating effectiveness data associated with the at least one suggested fraud rule.

Clause 10: The method of any of clauses 1-9, further comprising filtering, with at least one processor, the consortium transaction data such that the first issuer system does not receive the transaction data associated with the at least one second issuer.

Clause 11: A system for automatically generating a suggested fraud rule for an issuer, comprising at least one processor programmed or configured to: identify a first issuer from a plurality of issuers; determine a transaction volume category and a region category associated with the first issuer; determine at least one second issuer from the plurality of issuers, wherein each of the at least one second issuers is associated with the same transaction volume category and region category as the first issuer; associate the first issuer and the at least one second issuer to form an issuer consortium; obtain consortium transaction data associated with the issuer consortium, wherein the consortium transaction data comprises transaction data associated with the first issuer and transaction data associated with the at least one second issuer; generate at least one suggested fraud rule for the first issuer based on the consortium transaction data; and communicate the at least one suggested fraud rule to a first issuer system associated with the first issuer.

Clause 12: The system of clause 11, wherein generating the at least one suggested fraud rule comprises analyzing the consortium transaction data using a machine learning algorithm.

Clause 13: The system of clause 11 or 12, wherein the at least one processor is further programmed or configured to: segment the consortium transaction data based on at least one attribute.

Clause 14: The system of any of clauses 11-13, wherein the at least one suggested fraud rule for the first issuer is generated based on the segmented consortium transaction data.

Clause 15: The system of any of clauses 11-14, wherein the at least one attribute comprises transaction type.

Clause 16: The system of any of clauses 11-15, wherein the at least one attribute comprises at least one data element defined by ISO 8583.

Clause 17: The system of any of clauses 11-16, wherein the transaction volume category comprises only issuers conducting an average of fewer than 15,000 electronic payment transactions per day.

Clause 18: The system of any of clauses 11-17, wherein the region category comprises only issuers having transaction data in a predetermined country or geographic region, wherein the consortium transaction data comprises only transaction data associated with electronic payment transactions initiated in the predetermined country or geographic region.

Clause 19: The system of any of clauses 11-18, wherein communicating the at least one suggested fraud rule to a first issuer system comprises communicating effectiveness data associated with the at least one suggested fraud rule.

Clause 20: The system of any of clauses 11-19, wherein the at least one processor is further programmed or configured to: filter the consortium transaction data such that the first issuer system does not receive the transaction data associated with the at least one second issuer.

Clause 21: A computer program product for automatically generating a suggested fraud rule for an issuer, the computer program product comprising at least one non-transitory computer-readable medium including one or more instructions that, when executed by at least one processor, cause the at least one processor to: identify a first issuer from a plurality of issuers; determine a transaction volume category and a region category associated with the first issuer; determine at least one second issuer from the plurality of issuers, wherein each of the at least one second issuers is associated with the same transaction volume category and region category as the first issuer; associate the first issuer and the at least one second issuer to form an issuer consortium; obtain consortium transaction data associated with the issuer consortium, wherein the consortium transaction data comprises transaction data associated with the first issuer and transaction data associated with the at least one second issuer; generate at least one suggested fraud rule for the first issuer based on the consortium transaction data; and communicate the at least one suggested fraud rule to a first issuer system associated with the first issuer.

Clause 22: The computer program product of clause 21, wherein generating the at least one suggested fraud rule comprises analyzing the consortium transaction data using a machine learning algorithm.

Clause 23: The computer program product of clause 21 or 22, wherein the one or more instructions cause the at least one processor to: segment the consortium transaction data based on at least one attribute.

Clause 24: The computer program product of any of clauses 21-23, wherein the at least one suggested fraud rule for the first issuer is generated based on the segmented consortium transaction data.

Clause 25: The computer program product of any of clauses 21-24, wherein the at least one attribute comprises transaction type.

Clause 26: The computer program product of any of clauses 21-25, wherein the at least one attribute comprises at least one data element defined by ISO 8583.

Clause 27: The computer program product of any of clauses 21-26, wherein the transaction volume category comprises only issuers conducting an average of fewer than 15,000 electronic payment transactions per day.

Clause 28: The computer program product of any of clauses 21-27, wherein the region category comprises only issuers having transaction data in a predetermined country or geographic region, wherein the consortium transaction data comprises only transaction data associated with electronic payment transactions initiated in the predetermined country or geographic region.

Clause 29: The computer program product of any of clauses 21-28, wherein communicating the at least one suggested fraud rule to a first issuer system comprises communicating effectiveness data associated with the at least one suggested fraud rule.

Clause 30: The computer program product of any of clauses 21-29, wherein the one or more instructions cause the at least one processor to: filter the consortium transaction data such that the first issuer system does not receive the transaction data associated with the at least one second issuer.

### BRIEF DESCRIPTION OF THE DRAWINGS

FIG. 1 shows a schematic diagram of a system for automatically generating a suggested fraud rule for an issuer according to some non-limiting embodiments or aspects of the present disclosure;

FIG. 2 shows a step diagram of a method for automatically generating a suggested fraud rule for an issuer according to some non-limiting embodiments or aspects of the present disclosure;

FIG. 3 shows a process flow diagram of a method for automatically generating a suggested fraud rule for an issuer according to some non-limiting embodiments or aspects of the present disclosure;

FIG. 4 shows a process flow diagram of a method for automatically generating a suggested fraud rule for an issuer according to some non-limiting embodiments or aspects of the present disclosure;

FIG. 5 shows a graphical user interface displaying a suggested fraud rule according to some non-limiting embodiments or aspects of the present disclosure;

FIG. 6 shows a graphical user interface displaying effectiveness data for a fraud rule according to some non-limiting embodiments or aspects of the present disclosure; and

FIG. 7 shows a schematic diagram of some embodiments or aspects of components of one or more devices and/or one or more systems of FIGS. 1, 3, and 4.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the term “account data” as used herein, refers to any data concerning one or more accounts for one or more users. Account data may include, for example, one or more account identifiers, user identifiers, transaction histories, balances, credit limits, issuer institution identifiers, and/or the like.

As used herein, the term “account identifier” may include one or more types of identifiers associated with a user account (e.g., a primary account number (PAN), a card number, a payment card number, a token, and/or the like). In some non-limiting embodiments, an issuer institution may provide an account identifier (e.g., a PAN, a token, and/or the like) to a user that uniquely identifies one or more accounts associated with that user. The account identifier may be embodied on a payment device (e.g., a portable payment instrument, a payment card, a credit card, a debit card, and/or the like) and/or may be electronic information communicated to the user that the user may use for electronic payments. In some non-limiting embodiments, the account identifier may be an original account identifier, where the original account identifier was provided to a user at the creation of the account associated with the account identifier. In some non-limiting embodiments, the account identifier may be an account identifier (e.g., a supplemental account identifier) that is provided to a user after the original account identifier was provided to the user. For example, if the original account identifier is forgotten, stolen, and/or the like, a supplemental account identifier may be provided to the user. In some non-limiting embodiments, an account identifier may be directly or indirectly associated with an issuer institution, such that an account identifier may be a token that maps to a PAN or other type of identifier. Account identifiers may be alphanumeric, any combination of characters and/or symbols, and/or the like. An issuer institution may be associated with a bank identification number (BIN) that uniquely identifies the issuer institution.

As used herein, the term “acquirer institution” may refer to an entity licensed and/or approved by the transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments, an acquirer institution may be a financial institution, such as a bank. As used herein, the term “acquirer system” may refer to one or more computer systems, computer devices, software applications, and/or the like operated by or on behalf of an acquirer institution.

The term “client device,” as used herein, refers to any electronic device that is configured to communicate with one or more servers or remote devices and/or systems. A client device may include a mobile device, a network-enabled appliance (e.g., a network-enabled television, refrigerator, thermostat, and/or the like), a computer, a POS system, and/or any other device or system capable of communicating with a network.

As used herein, the terms “communication” and “communicate” may refer to the reception, receipt, transmission, transfer, provision, and/or the like, of information (e.g., data, signals, messages, instructions, commands, and/or the like). For one unit (e.g., a device, a system, a component of a device or system, combinations thereof, and/or the like), to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices that are configured to directly or indirectly communicate with or over one or more networks. The computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may be a non-mobile device, such as a desktop computer. Furthermore, the term “computer” may refer to any computing device that includes the necessary components to receive, process, and output data, and normally includes a display, a processor, a memory, an input device, and a network interface. An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, etc.).

As used herein, the term “issuer institution” may refer to one or more entities, such as a bank, that provide accounts to users for conducting transactions (e.g., payment transactions), such as initiating credit and/or debit payments. For example, an issuer institution may provide an account identifier, such as a PAN, to a user that uniquely identifies one or more accounts associated with that user. The account identifier may be embodied on a payment device, such as a physical financial instrument, e.g., a payment card, and/or may be electronic and used for electronic payments. The term “issuer system” refers to one or more computer systems, computing devices, software applications, and/or the like, operated by or on behalf of an issuer institution, such as a server computer executing one or more software applications. For example, an issuer system may include one or more authorization servers for authorizing a transaction, one or more authentication servers for authenticating a transaction, and/or one or more databases of account data. An issuer system may include a separate or integrated issuer authentication system, such as an Access Control Server (ACS), for authenticating online transactions. An issuer institution may be associated with the BIN or other unique identifier that uniquely identifies it among other issuer institutions.

As used herein, the term “merchant” may refer to an individual or entity that provides goods and/or services, or access to goods and/or services, to users (e.g., consumers) based on a transaction (e.g., an electronic payment transaction). The term “merchant system” may refer to one or more computer systems, computing devices, and/or software applications operated by or on behalf of a merchant, such as a server computer executing one or more software applications. As used herein, the term “point-of-sale (POS) system” may refer to one or more computers and/or peripheral devices used by a merchant to engage in payment transactions with users, including one or more card readers, near-field communication (NFC) receivers, radio frequency identification (RFID) receivers, and/or other contactless transceivers or receivers, contact-based receivers, payment terminals, computers, servers, input devices, and/or other like devices that can be used to initiate a payment transaction. A POS system may be part of a merchant system. A merchant system may also include a merchant plug-in for facilitating online, Internet-based transactions through a merchant webpage or software application. A merchant plug-in may include software that runs on a merchant server or is hosted by a third-party for facilitating such online transactions.

As used herein, the term “payment device” may refer to a portable financial device, an electronic payment device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, PDA, a pager, a security card, a computer, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, POS devices, mobile devices, etc.) directly or indirectly communicating in the network environment may constitute a “system.” As used herein, the term “server” or “processor” may refer to one or more devices that provide a functionality to one or more devices (e.g., one or more client devices) via a network (e.g., a public network, a private network, the Internet, and/or the like). For example, a server may include one or more computing devices. As used herein, the term “system” may refer to one or more devices, such as one or more processors, servers, client devices, computing devices that include software applications, and/or the like. In some non-limiting embodiments or aspects, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor, that is recited as performing a first step or function, may refer to the same or different server and/or a processor recited as performing a second step or function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as VISA® or any other entity that processes transactions. As used herein, the term “transaction processing system” may refer to one or more computer systems operated by or on behalf of a transaction service provider, such as a transaction processing server executing one or more software applications. A transaction processing server may include one or more processors and, in some non-limiting embodiments, may be operated by or on behalf of a transaction service provider.

Non-limiting embodiments or aspects of the present disclosure are directed to a method, system, and computer program product for automatically generating a suggested fraud rule for an issuer. Non-limiting embodiments or aspects enable generation of comprehensive and targeted suggested fraud rules specific to any type of issuer, regardless of the volume of electronic payment transactions (also referred to hereinafter as “transactions”) handled by the issuer or the geographic region in which the issuer handles transactions. Non-limiting embodiments or aspects form a customized consortium of transaction data including transaction data associated with a plurality of issuers (an issuer consortium), based on the type of issuer for which the fraud rules are to be generated. The consortium transaction data may include transaction data associated with a plurality of issuers having the same or similar size (e.g., by transaction volume) and/or operating in the same geographic region. This allows smaller issuers with less transaction volume to utilize effective fraud rules since the consortium transaction data includes statistically significant transaction data (beyond just the transaction data for that small issuer) relevant to the small issuer, from which useful suggested fraud rules can be generated. Moreover, the consortium transaction data including issuer size-specific data and/or geographic-specific data enables more accurate fraud rules to be generated, as fraudulent transaction trends and patterns can vary based on both issuer size and geographic region. Non-limiting embodiments or aspects enable further segmentation based on at least one additional attribute useful for determining fraudulent transaction trends and patterns. Overall, the method, system, and computer program product for automatically generating a suggested fraud rule for an issuer enables more accurate fraud rules to be generated for any type of issuer, thereby enhancing security for users initiating electronic payment transactions by reducing fraud risks associated with electronic payment transactions.

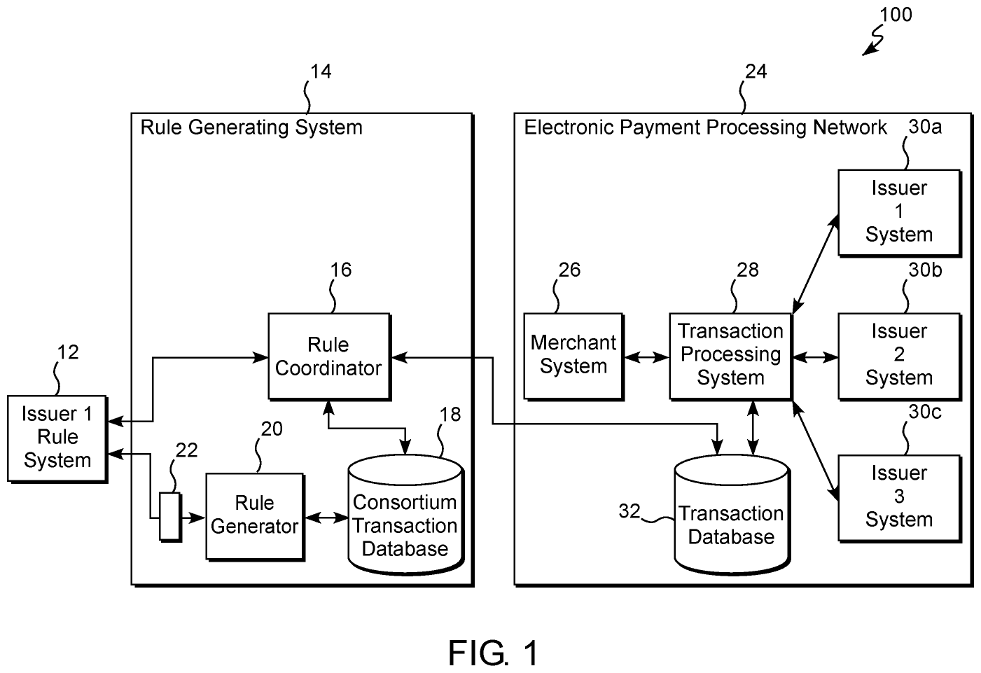

FIG. 1 shows some non-limiting embodiments or aspects of a system 100 for automatically generating a suggested fraud rule for an issuer. The system may include a first issuer rule system 12 operated by or on behalf of a first issuer. The first issuer rule system 12 may communicate with a rule generating system 14 to receive suggested fraud rules therefrom. The rule generating system 14 refers to one or more computer systems, computing devices, software applications, and/or the like operated by or on behalf of an entity (e.g., a transaction service provider, merchant, issuer, acquirer, and/or the like), such as a server computer executing one or more software applications.

The rule generating system 14 may include a rule coordinator 16, a consortium transaction database 18, a rule generator 20, and/or a filter 22. The rule coordinator 16 may communicate with an electronic payment processing network 24. The electronic payment processing network 24 may include a merchant system 26 operated by or on behalf of a merchant, a transaction processing system 28 operated by or on behalf of a transaction service provider, and at least one issuer system 30a-30c operated by or on behalf of at least one issuer. The electronic payment processing network 24 may include a transaction database 32.

With continued reference to FIG. 1, in some non-limiting embodiments or aspects, the electronic payment processing network 24 may process electronic payment transactions, such as credit and/or debit transactions, between users (e.g., consumers) and merchants. The user may initiate a payment transaction with the merchant system 26, and the merchant system 26 may process the payment transaction by communicating with the transaction processing system 28 and the at least one issuer system 30a-30c. Processing the payment transaction may include authorizing, clearing, and settling the payment transaction. The transaction processing system 28 and the at least one issuer system 30a-30c may be associated with the transaction service provider associated with the payment device of the user and issuer that issued the payment device to the user, respectively.

The transaction processing system 28 may communicate and store at least a portion of the transaction data associated with transactions processed by the electronic payment processing network 24 in the transaction database 32. The transaction data stored in the transaction database may include the transaction type for each transaction, data associated with data elements defined by ISO 8583 for each transaction, and/or any other relevant data associated with each transaction. The transaction database 32 may include transaction data associated with transactions involving a plurality of issuers, including issuers of different types (e.g., having a different size (different transaction volume categories), processing transactions from a different geographic region (different region categories), and/or the like).

Issuer size may be defined by the transaction volume processed by the issuer. Transaction volume may be determined by the number (e.g., average number) of transactions processed by the issuer over a given period of time, such as transactions per hour, per day, per week, per month, per quarter, per year, and the like. Issuers may be grouped into issuer size categories (transaction volume categories), which include only issuers of similar size. The transaction volume categories may be defined in any suitable manner into issuer groupings of different size. One non-limiting embodiment of transaction volume categories is shown as follows:

| | Average Daily |
|---|---|
| Issuer | Transaction |
| Size | Volume |
| Small | <15,000 |
| Medium | 15,000-100,000 |
| Large | >100,000 |

Issuers of similar size may experience similar types and/or patterns of fraudulent activity.

Transactions processed by issuers may be grouped into geographic regions based on the geographic location at which the transaction processed by the issuer was initiated. The geographic location at which the transaction was initiated may be indicated in the transaction data thereof, such as based on at least one of the data elements of ISO 8583, or other data collected during processing of the transaction which may indicate a geographic location associated with the transaction. Geographic regions associated with transactions may be defined in any suitable manner. For example, transactions may be grouped by country (e.g., United States, Canada, and Mexico transactions grouped separately). For example, transactions may be grouped more specifically by regions within a country (e.g., Pennsylvania and California transactions grouped separately, or Northeast United States, Pacific Northwest United States, and Midwest United States transactions grouped separately). For example, transactions may be grouped by multi-country regions, which regions include multiple countries (e.g., North American countries, European Union countries, and Middle East countries transactions grouped separately). Some combination of these geographic region grouping types may be used, which may be determined based on fraud patterns. One non-limiting embodiment of issuer geographic region categories is shown as follows:

Geographic Regions
United States of America
Canada
Asia Pacific
Latin America
Central Europe, Middle East,
and Africa (CEMEA)
European Union

Transactions initiated in similar geographic regions may experience similar types and/or patterns of fraudulent activity.

With continued reference to FIG. 1, in some non-limiting embodiments or aspects, the rule generating system 14 (e.g., the rule coordinator 16 thereof) may receive a rule request from the first issuer rule system 12, which the rule request may cause the rule generating system 14 to generate and return at least one suggested fraud rule for the first issuer rule system 12. The rule request may include at least one issuer identifier unique to the first issuer to enable the rule generating system 14 to identify the first issuer from a plurality of issuers. Based on the issuer identifier, the rule generating system 14 may identify the first issuer from a plurality of issuers. Based on the identified first issuer, the rule generating system 14 may determine a transaction volume category and region category associated with the first issuer.

With continued reference to FIG. 1, in some non-limiting embodiments or aspects, the rule generating system 14 may determine at least one second issuer from the plurality of issuers, which second issuers may be associated with the first issuer to form an issuer consortium. The second issuers may be associated with the same transaction volume category as the first issuer (e.g., be issuers of similar size). The second issuers may process at least some transactions in the same geographic region. In some non-limiting examples, only small issuers (e.g., <15,000 transactions/day) processing transactions in a particular geographic region (e.g., the United States) may be associated to form an issuer consortium.

With continued reference to FIG. 1, in some non-limiting embodiments or aspects, the rule coordinator 16 may communicate with the transaction database 32 to obtain at least a portion of the transaction data contained in the transaction database 32. The portion of the transaction data obtained by the rule coordinator 16 may include only transaction data associated with transactions involving the issuer consortium of issuers similar to the first issuer associated with the first issuer rule system 12. For example, the portion of the transaction data may include only transaction data associated with transactions involving issuers having a similar size compared to the first issuer associated with the first issuer rule system 12. For example, the portion of the transaction data may include only transaction data associated with transactions initiated in a predetermined geographic region by those issuers. This portion of the transaction data may constitute consortium transaction data.

The rule coordinator 16 may further segment the portion of the transaction data obtained from the transaction database 32 by another attribute, such as by transaction type (e.g., cross-border transaction, e-commerce transaction, automated teller machine (ATM) withdrawal transaction, brick-and-mortar transaction, autopay transaction, contactless transaction, and the like), or another data element defined by ISO 8583, or any other attribute of transaction data that may usefully segment the transaction data based on fraud trends. Non-limiting examples of attributes by which to segment the transaction data include: card-not-present/card-present transactions, transaction type, point-of-sale terminal type, merchant category code, point-of-sale condition code, point-of-sale entry mode, or other attribute which may be determined to be associated with similar types and/or patterns of fraudulent activity. This further segmented data may also constitute consortium transaction data. Each separate segment of the data may be separately analyzed for suggested fraud rules, as each different segment may experience different types and/or patterns of fraudulent activity.

With continued reference to FIG. 1, in some non-limiting embodiments or aspects, the rule coordinator 16 may communicate the consortium transaction data to the consortium transaction database 18 to store the consortium transaction data thereon. The rule generator 20 may communicate with the consortium transaction database 18 and may generate at least one suggested fraud rule based on the consortium transaction data. The rule generator 20 may analyze the consortium transaction data using at least one machine learning algorithm to generate the at least one suggested fraud rule. The machine learning algorithm may analyze the consortium transaction data to detect patterns indicative of fraudulent activity and may generate the at least one suggested fraud rule according to the detected pattern.

The generated suggested fraud rule may specify conditions associated with future transactions which, if present, may suggest that the particular transaction is fraudulent. Thus, the suggested fraud rules may help identify fraudulent transactions during processing of the transactions. The suggested fraud rule may include at least one condition which, if satisfied by the future transaction, may cause the transaction to be flagged as potentially fraudulent and/or automatically declined for being potentially fraudulent by at least one of the merchant system 26, the transaction processing system 28, the issuer system 30a-30c, and/or the like.

The rule generator 20 may generate the fraud rule as a case creation fraud rule and/or a real-time fraud rule. The case creation fraud rule may allow the subject transaction to proceed, but may automatically initiate an investigation of the transaction that has occurred to determine whether the transaction was fraudulent. The real-time fraud rule may immediately terminate the subject transaction by declining the transaction before further processing thereof. The rule generator 20 may suggest that the fraud rule be a case creation fraud rule and/or a real-time fraud rule.

With continued reference to FIG. 1, in some non-limiting embodiments or aspects, the rule generator 20 may communicate the at least one suggested fraud rule to the first issuer rule system 12. This may include communicating effectiveness data (described hereinafter) associated with the at least one fraud rule. Communicating the suggested fraud rule to the first issuer rule system 12 may cause the suggested fraud rule to be implemented for subsequent transactions.

The rule generating system 14 may include a filter 22 between the rule generator 20 and the issuer rule system 12. The filter 22 may include a data privacy rule filter. The filter may filter any identifiable transaction data not associated with the first issuer associated with the issuer rule system 12, such that the first issuer associated with the first issuer rule system 12 does not receive any identifiable transaction data associated with another issuer from the issuer consortium.

With continued reference to FIG. 1, in some non-limiting embodiments or aspects, in response to receiving the suggested fraud rules from the rule generator 20, the first issuer rule system 12 may accept the suggested fraud rules and cause the accepted suggested fraud rules to be implemented for subsequently initiated transactions. This may include the first issuer rule system 12 communicating a rule implementation message to at least one of the merchant system 26, the transaction processing system 28, and the issuer systems 30a-30c to cause the accepted suggested fraud rules to be implemented. In response to receiving the suggested fraud rules from the rule generator 20, the first issuer rule system 12 may reject at least one of the suggested fraud rules, such that the rejected suggested fraud rule is not implemented for subsequently initiated transactions.

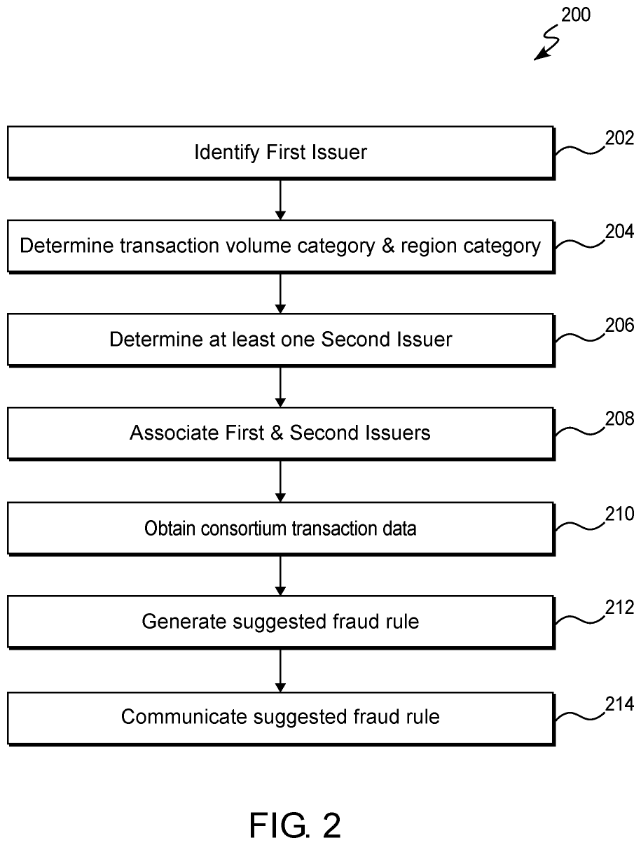

Referring to FIG. 2, a method 200 is shown for automatically generating a suggested fraud rule for an issuer according to some non-limiting embodiments or aspects. At step 202, the rule generating system may identify the first issuer from a plurality of issuers. At step 204, the rule generating system may determine the transaction volume category and the region category associated with the first issuer. At step 206, the rule generating system may determine at least one second issuer from the plurality of issuers, wherein each of the at least one second issuers is associated with the same transaction volume category and region category as the first issuer. At step 208, the rule generating system may associate the first issuer and the at least one second issuer to form an issuer consortium. At step 210, the rule generating system may obtain consortium transaction data associated with the issuer consortium, wherein the consortium transaction data comprises transaction data associated with the first issuer and transaction data associated with the at least one second issuer. At step 212, the rule generating system may generate at least one suggested fraud rule for the first issuer based on the consortium transaction data. At step 214, the rule generating system may communicate the at least one suggested fraud rule to a first issuer system associated with the first issuer.

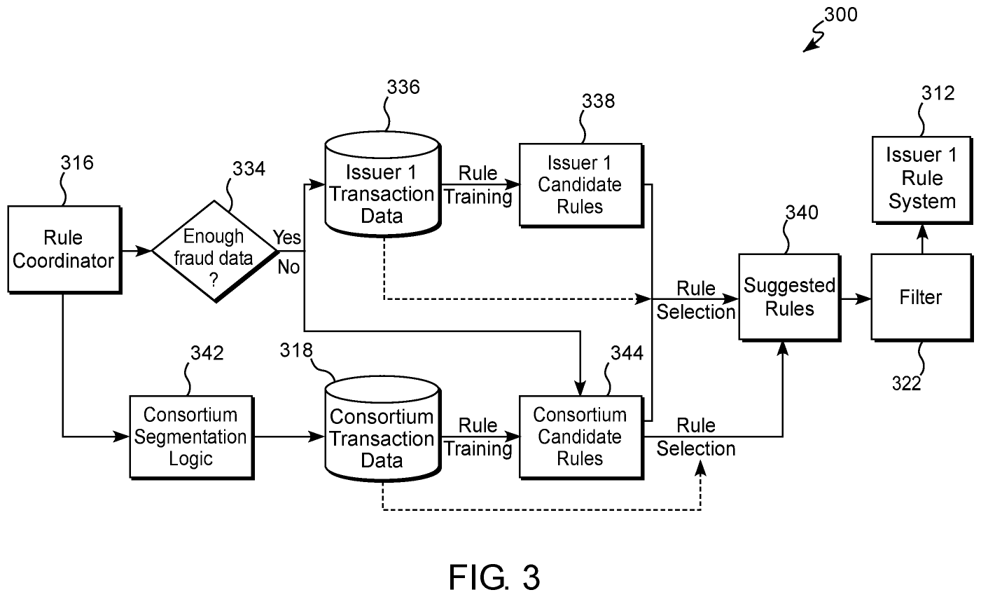

Referring to FIG. 3, a method 300 is shown for automatically generating a suggested fraud rule for an issuer according to some non-limiting embodiments or aspects. The rule generating system may receive a rule request from the first issuer rule system 312 associated with a first issuer to generate suggested fraud rules. At step 334, the rule generating system (e.g., the rule coordinator 316 thereof) may determine whether there is enough fraud data associated with the first issuer submitting the rule request to generate fraud rules therefor without forming an issuer consortium. The rule generating system may determine whether at least a threshold amount of transaction data is associated with the first issuer within a predetermined time period (e.g., a recent time period) to generate reliable suggested fraud rules. This may include a threshold amount of data from the most recent week, month, quarter, year, or the like. In some non-limiting embodiments or aspects, medium and large size issuers (e.g., >15,000 transactions processed per day) may include the threshold amount of transaction data to generate suggested fraud rules without considering transaction data for other issuers (without forming an issuer consortium). The threshold amount of transaction data may represent a statistically significant amount of transaction data. However, in some non-limiting examples, medium and/or large size issuer transaction data may be included in consortiums of like issuers, and that consortium transaction data may be used to generate suggested fraud rules for medium and/or large size issuers.

In some non-limiting embodiments or aspects, in response to the rule generating system determining that the threshold amount of transaction data exists for the first issuer, the transaction data associated with that first issuer, which may be stored in a first issuer transaction data database 336, may be used by itself by the rule generating system (e.g., the rule generator) to generate suggested fraud rules 340, as described above. The rule generator may generate a plurality of first issuer candidate fraud rules 338 based on the data stored in the first issuer transaction data database 336, which first issuer candidate fraud rules 338 may be further narrowed down to form the suggested fraud rules 340 to suggest to the first issuer rule system 312. The first issuer candidate fraud rules 338 may be narrowed to form the suggested fraud rules based on determining effectiveness data for the first issuer candidate fraud rules 338 to determine which first issuer candidate fraud rules 338 are empirically most effective. The effectiveness data may be determined based on applying the first issuer candidate fraud rules 338 to past transaction data to determine their effectiveness in accurately identifying fraudulent transactions, as hereinafter described. The rule generator may generate a plurality of suggested fraud rules 340 based on the data stored in the first issuer transaction data database 336 without first generating first issuer candidate fraud rules 338.

In some non-limiting embodiments or aspects, in response to the rule generating system determining that the threshold amount of transaction data does not exist for the first issuer, the rule generating system may initiate consortium segmentation logic 342 to generate consortium transaction data. The consortium segmentation logic 342 may cause the rule generating system to identify the first issuer from a plurality of issuers, determine a transaction volume category and a region category associated with the first issuer, determine at least one second issuer from the plurality of issuers, wherein each of the at least one second issuers is associated with the same transaction volume category and region category as the first issuer, and/or associate the first issuer and the at least one second issuer to form an issuer consortium, as previously described. In response to forming the issuer consortium, the consortium segmentation logic 342 may additionally cause the rule generating system to obtain consortium transaction data associated with the issuer consortium and store the consortium transaction data in the consortium transaction database 318.

The consortium segmentation logic 342 may, in some non-limiting embodiments or aspects, additionally cause the rule generating system to segment the portion of the consortium transaction data in the consortium transaction database 318 by another attribute, as previously described, to form consortium transaction data. Based on the consortium transaction data stored in the consortium transaction database 318, the rule generator may generate suggested fraud rules 340, as described above. The rule generator may generate a plurality of consortium candidate fraud rules 344 (relevant to any issuer whose transaction data is included in the consortium transaction database 318 including the first issuer requesting the suggested fraud rules), which consortium candidate fraud rules 344 may be further narrowed down to form the suggested fraud rules 340 to suggest to the first issuer rule system 312.

The consortium candidate fraud rules 344 may be narrowed to form the suggested fraud rules based on determining effectiveness data for the consortium candidate fraud rules 344 to determine which consortium candidate fraud rules 344 are empirically most effective. The effectiveness data may be determined based on applying the consortium transaction database 318 to past transaction data to determine their effectiveness in accurately identifying fraudulent transactions, as hereinafter described. The past transactions may include past transactions from the consortium of issuers or only the past transactions specific to the first issuer requesting the suggested fraud rules. The rule generator may generate a plurality of suggested fraud rules 340 based on the consortium transaction database 318 without first generating consortium candidate fraud rules 344.

With continued reference to FIG. 3, in some non-limiting embodiments or aspects, the rule generating system may communicate the suggested fraud rules 340 to the first issuer rule system 312. The rule generating system may include a filter 322 between the rule generator and the first issuer rule system 312, as previously described.

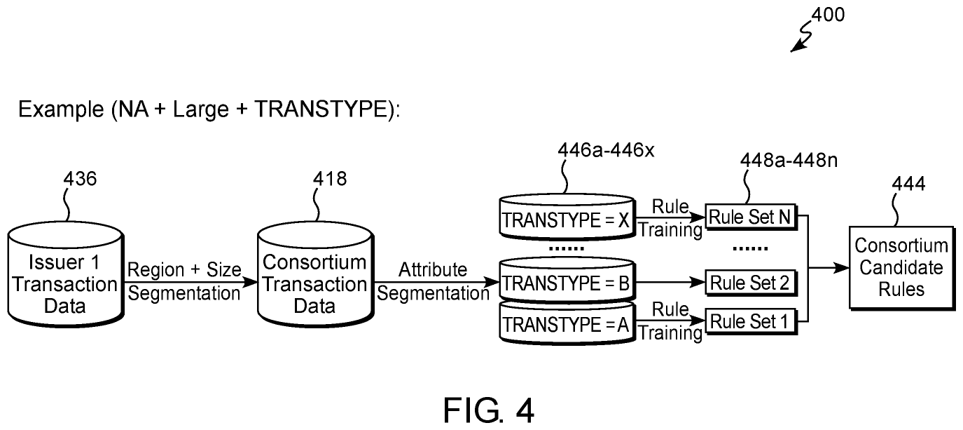

Referring to FIG. 4, a method 400 is shown for automatically generating a suggested fraud rule for an issuer according to some non-limiting embodiments or aspects. The method of FIG. 4 specifically shows the method 400 further segmenting the transaction data based on at least one attribute beyond issuer size and transaction geographic region. In this non-limiting example, the transaction data specific to a first issuer is combined with transaction data from at least one second issuer to form an issuer consortium and the corresponding consortium transaction data.

With continued reference to FIG. 4, the first issuer transaction data database 436 may include transaction data associated only with transactions processed by the first issuer. In this non-limiting example from FIG. 4, at least a portion of the transaction data from the first issuer transaction data database 436 may be stored in the consortium transaction database 418. In this non-limiting example, the rule generating system generates an issuer consortium based on an issuer size and geographic region segmentation. This issuer consortium database 418 includes transaction data from large issuers (e.g., with a daily transaction volume exceeding 100,000) for transaction initiated in the North America region. Therefore, in this non-limiting example, the consortium transaction database 418 includes this size-region segmented data, including the relevant data from the first issuer transaction data database 436 (because the first issuer in this scenario is a large issuer with at least a portion of its transactions processed being initiated in North America). It will be appreciated that other size-region segmentations may be performed using this same protocol (e.g., small issuers in North America).

With continued reference to FIG. 4, in some non-limiting embodiments or aspects, at least a portion of the data stored in the consortium transaction database 418 may be further segmented based on at least one of the previously-described attributes. In the specific non-limiting example of FIG. 4, the data stored in the consortium transaction database 418 may be further segmented based on transaction type, such that transactions of each transaction type may be separately analyzed for suggested fraud rules. The further segmented transaction data may be stored in separate attribute databases 446a-446x, each of which include only transaction data associated with the corresponding attribute (in this example—transaction type). The rule generator may generate at least one suggested fraud rule associated with the data stored in each of the separate attribute databases 446a-446x to form attribute rule sets 448a-448n, reflecting that each different type of a specific attribute may be associated with different types and/or patterns of fraudulent activity (e.g., different types and/or patterns of fraudulent activity may be associated with cross-border transactions compared to e-commerce transactions). While described in connection with the transaction type attribute, it will be appreciated that this protocol may be effected for any attribute or combination of attributes.

With continued reference to FIG. 4, the suggested fraud rules generated for the first issuer based on issuer size and region segmentation or based on issuer size, region, and attribute segmentation may form the consortium candidate rules 444. The consortium candidate rules 444 may be applicable for the first issuer and/or any other issuer sharing the same issuer size, region, and/or attributes, whose transaction data may also have been included in the consortium transaction database 418. At least a subset of the consortium candidate rules 444 may be communicated to the first issuer rule system as suggested fraud rules.

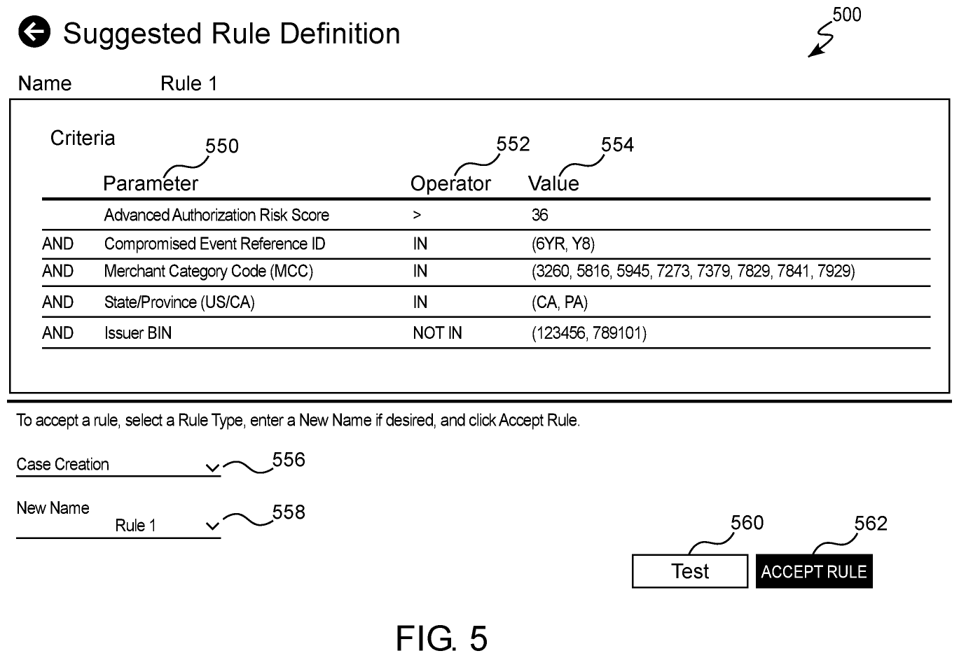

Referring to FIG. 5, a graphical user interface (GUI) 500 is shown of a suggested fraud rule according to some non-limiting embodiments or aspects. In response to the rule generating system communicating the suggested fraud rules to the first issuer rule system, the first issuer rule system may display the suggested fraud rules. The GUI 500 may display data associated with the suggested fraud rules in any suitable arrangement. The GUI 500 may display the parameters 550, the operators 552, and/or the values 554 associated with a suggested fraud rule.

The parameters 550 include the transaction data suggested by the suggested fraud rule to be analyzed for future transactions in order to determine whether the transaction is potentially fraudulent. These parameters 550 may include any transaction data generated and/or received during the transaction, such as those elements defined by ISO 8583. A suggested fraud rule may specify a single parameter 550 or a plurality of alternative and/or additional parameters 550. For example, the suggested fraud rule shown in FIG. 5 includes 5 parameters 550 to consider together.

With continued reference to FIG. 5, each parameter 550 may have a corresponding operator 552 specifying a function to be applied to the corresponding parameter 550. Non-limiting examples of the operators 552 include: greater than, less than, equal to, not equal to, greater than or equal to, less than or equal to, within the range of, outside the range of, includes, not includes, and the like.

Each parameter 550 and operator 552 may have a corresponding value 554, specifying the specific value or range of values which, in combination with the corresponding parameter 550 and operator 552, define the transaction data satisfying and not satisfying the suggested fraud rule. As one non-limiting example from FIG. 5, one parameter 550 considered in the suggested fraud rule is the authorization risk score which, based on the corresponding operator 552 and value 554, indicates that a risk score greater than a value of 36 satisfies this specific parameter of the rule.

With continued reference to FIG. 5, in some non-limiting embodiments or aspects, the GUI 500 may specify a rule type 556 associated with the rule, such as the rule being the case creation fraud rule or the real-time fraud rule or any other contemplated rule type. The rule generating system may suggest the rule type 556, which the first issuer rule system may accept or modify, or the first issuer rule system may specify the rule type without a suggestion from the rule generating system.

With continued reference to FIG. 5, in some non-limiting embodiments or aspects, the GUI 500 may include a name field 558, which enable the first issuer rule system to associate a rule name with a suggested fraud rule. With continued reference to FIG. 5, in some non-limiting embodiments or aspects, the GUI 500 may enable a user to test 560 the displayed suggested fraud rule. Testing the displayed suggested fraud rule may include displaying effectiveness data received from the rule generating system and/or the first issuer rule system applying a suggested fraud rule to transaction data from the first issuer rule system to determine the effectiveness of a suggested fraud rule.

With continued reference to FIG. 5, in some non-limiting embodiments or aspects, the GUI 500 may include a selectable option 562 configured to enable a user to accept a suggested fraud rule or reject a suggested fraud rule. Accepting a suggested fraud rule may cause the suggested fraud rule to be implemented for future transactions associated with the issuer. Rejecting a suggested fraud rule may cause the suggested fraud rule to not be implemented in future transactions associated with the issuer.

With continued reference to FIG. 5, in some non-limiting embodiments, the GUI 500 may display the suggested fraud rule generated by the rule generating system. The GUI 500 may enable a user to modify at least a portion of the suggested fraud rule, such as the parameter 550, the operator 552, the value 554, the rule type 556, the rule name 558, and/or the like. The first issuer rule system 12 may test 560 the modified rule. The first issuer rule system may use the selectable option 562 to accept (thereby implementing) or reject (thereby not implementing) the modified suggested fraud rule.

With continued reference to FIG. 5, in some non-limiting embodiments, the GUI 500 may enable the first issuer rule system to create a suggested fraud rule without a fraud rule being suggested by the rule generating system. The GUI 500 enables the first issuer rule system to specify a suggested fraud rule by specifying the parameters 550, the operators 552, the values 554, the rule types 556, the rule names 558, and/or the like. The first issuer rule system may test 560 the issuer rule system-created suggested fraud rule using the issuer consortium data as previously described. The first issuer rule system may use the selectable option 562 to accept (thus implementing) or reject (thereby not implementing) the issuer rule system-created suggested fraud rule.

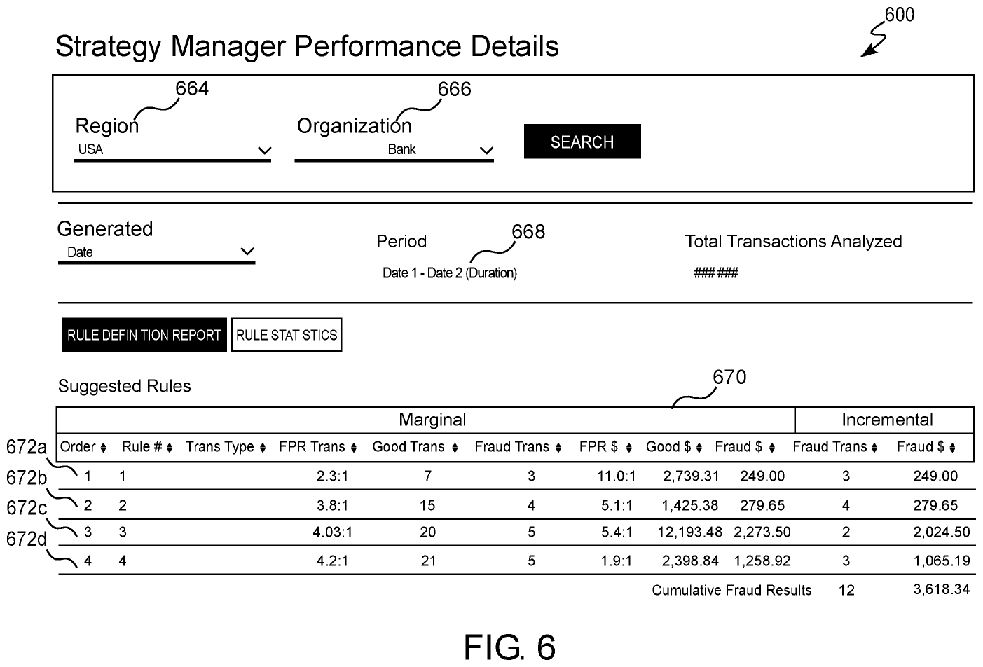

Referring to FIG. 6, a graphical user interface (GUI) 600 is shown which displays effectiveness data for a fraud rule according to some non-limiting embodiments or aspects. The effectiveness data may include data which analyzes and/or shows how effective a suggested fraud rule is by applying the suggested fraud rule to previous transaction data, which serves to test the suggested rule as previously discussed. The rule generating system may generate the suggested fraud rules and the effectiveness data and communicate the effectiveness data to the first issuer rule system with the suggested fraud rules. The first issuer rule system may generate the effectiveness data in response to receiving the suggested fraud rules.

With continued reference to FIG. 6, the GUI 600 may enable the rule generating system and/or first issuer rule system to specify a region 664 and/or an organization 666 from which the data to test the suggested fraud rule is to come (e.g., which transaction data to use as test data). The region 664 may be any of the previously-described geographic regions in which a transaction may be initiated. In this non-limiting example, the region 664 includes a transaction initiated in the United States. The organization 666 may be the issuer and/or issuer consortium whose transaction data is to be used. This may include a single issuer bank's or a plurality of issuer banks' previous transaction data.

The GUI 600 may enable the rule generating system and/or the first issuer rule system to specify a period 668 over which the previous transaction data should be pulled to effect the test to generate the effectiveness data for the suggested fraud rule. The period may include a start date (Date 1) and an end date (Date 2), such that data ranging from Date 1 to Date 2 is included in the test of the suggested fraud rule. The period 668 may include the most recent week(s), month(s), quarter(s), year(s), or the like. The GUI 600 may display the total number of transactions analyzed based on the specified region 664, the organization 666, and/or the period 668. With continued reference to FIG. 6, in some non-limiting embodiments or aspects, the GUI 600 may display an effectiveness data 670 associated with each suggested fraud rule 672a-672d. As shown in the non-limiting example of FIG. 6, the effectiveness data 670 for four separate suggested fraud rules 672a-672d is displayed.

The effectiveness data may include, but is not limited to the number of fraudulent transactions identified by applying the suggested fraud rule, the number of non-fraudulent transactions identified by applying the suggested fraud rule, the percent of correctly identified fraudulent transactions by applying the suggested fraud rule, the percent of incorrectly identified fraudulent transactions by applying the suggested fraud rule, the percent of correctly identified non-fraudulent transactions by applying the suggested fraud rule, the percent of incorrectly identified non-fraudulent transactions by applying the suggested fraud rule, a ratio involving fraudulent and/or non-fraudulent transactions identified and/or correctly and/or incorrectly identified by applying the suggested fraud rule, an amount of fraudulent funds prevented from being processed by applying the suggested fraud rule, an amount of non-fraudulent funds prevented from being processed by applying the suggested fraud rule, a ratio of fraudulent and/or non-fraudulent funds prevented from being processed by applying the suggested fraud rule, and/or any such data associated with combining implementation of two or more suggested fraud rules, and/or the like.

With continued reference to FIG. 6, the first issuer rule system may automatically accept or reject implementation of a suggested fraud rule based at least in part on the effectiveness data thereof. The first issuer rule system may automatically accept or reject implementation of a suggested fraud rule based on at least a portion of the effectiveness data, or combination thereof being above or below a threshold level.

In a further, non-limiting embodiment or aspect, a computer program product for automatically generating a suggested fraud rule for an issuer includes at least one non-transitory computer readable medium including program instructions that, when executed by at least one processor, cause the at least one processor to execute one of the previously-described methods. The at least one processor may include the rule generating system (e.g., the rule coordinator and/or the rule generator) and/or the first issuer rule system.

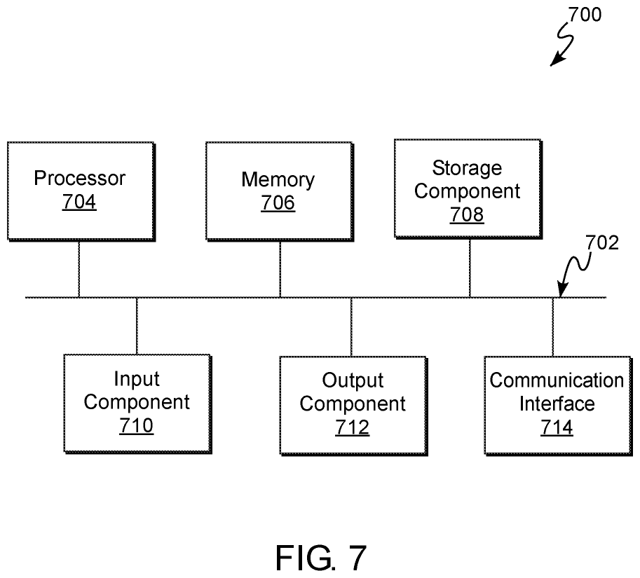

Referring to FIG. 7, a diagram is shown of example components of a device and/or system 700. The device and/or system 700 may correspond to any of the components shown in FIGS. 1, 3, and 4, which may include at least one device and/or system 700 and/or at least one component of device and/or system 700. As shown in FIG. 7, device and/or system 700 may include a bus 702, a processor 704, a memory 706, a storage component 708, an input component 710, an output component 712, and a communication interface 714.

The bus 702 may include a component that permits communication among the components of the device and/or system 700. In some non-limiting embodiments, the processor 704 may be implemented in hardware, software, or a combination of hardware and software. For example, the processor 704 may include a processor (e.g., a central processing unit (CPU), a graphics processing unit (GPU), an accelerated processing unit (APU), and/or the like), a microprocessor, a digital signal processor (DSP), and/or any processing component (e.g., a field-programmable gate array (FPGA), an application-specific integrated circuit (ASIC), and/or the like) that can be programmed to perform a function. The memory 706 may include random access memory (RAM), read-only memory (ROM), and/or another type of dynamic or static storage memory (e.g., flash memory, magnetic memory, optical memory, and/or the like) that stores information and/or instructions for use by the processor 704.

The storage component 708 may store information and/or software related to the operation and use of the device and/or system 700. For example, the storage component 708 may include a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, and/or another type of computer-readable medium, along with a corresponding drive.

The input component 710 may include a component that permits the device and/or system 700 to receive information, such as via user input (e.g., a touch screen display, a keyboard, a keypad, a mouse, a button, a switch, a microphone, and/or the like). Additionally or alternatively, the input component 710 may include a sensor for sensing information (e.g., a global positioning system (GPS) component, an accelerometer, a gyroscope, an actuator, and/or the like). The output component 712 may include a component that provides output information from the device and/or system 700 (e.g., a display, a speaker, one or more light-emitting diodes (LEDs), and/or the like).

The communication interface 714 may include a transceiver-like component (e.g., a transceiver, a separate receiver and transmitter, etc.) that enables device and/or system 700 to communicate with other devices and/or systems, such as via a wired connection, a wireless connection, or a combination of wired and wireless connections. The communication interface 714 may permit the device and/or system 700 to receive information from another device and/or provide information to another device. For example, the communication interface 714 may include an Ethernet interface, an optical interface, a coaxial interface, an infrared interface, a radio frequency (RF) interface, a universal serial bus (USB) interface, a Wi-Fi® interface, a cellular network interface, and/or the like.

The device and/or system 700 may perform one or more processes described herein. The device and/or system 700 may perform these processes based on the processor 704 executing software instructions stored by a computer-readable medium, such as the memory 706 and/or the storage component 708. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into the memory 706 and/or the storage component 708 from another computer-readable medium or from another device via the communication interface 714. When executed, software instructions stored in the memory 706 and/or the storage component 708 may cause the processor 704 to perform one or more processes described herein. Additionally or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 7 are provided as an example. In some non-limiting embodiments, the device and/or system 700 may include additional components, fewer components, different components, or differently arranged components than those shown in FIG. 7. Additionally or alternatively, a set of components (e.g., one or more components) of the device and/or system 700 may perform one or more functions described as being performed by another set of components of the device and/or system 700.

Although the disclosure has been described in detail for the purpose of illustration based on what is currently considered to be the most practical and preferred embodiments, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A method for automatically generating a suggested fraud rule for an issuer, comprising:
identifying, with at least one processor, a first issuer from a plurality of issuers;
determining, with at least one processor, a transaction volume category and a region category associated with the first issuer;
determining, with at least one processor, at least one second issuer from the plurality of issuers, wherein each of the at least one second issuers is associated with the same transaction volume category and region category as the first issuer;
associating, with at least one processor, the first issuer and the at least one second issuer to form an issuer consortium;
obtaining, with at least one processor, consortium transaction data associated with the issuer consortium, wherein the consortium transaction data comprises transaction data associated with the first issuer and transaction data associated with the at least one second issuer;
generating, with at least one processor, at least one suggested fraud rule for the first issuer based on the consortium transaction data; and
communicating, with at least one processor, the at least one suggested fraud rule to a first issuer system associated with the first issuer.

2. The method of claim 1, wherein generating the at least one suggested fraud rule comprises analyzing, with at least one processor, the consortium transaction data using a machine learning algorithm.

3. The method of claim 1, further comprising:
segmenting, with at least one processor, the consortium transaction data based on at least one attribute.

4. The method of claim 3, wherein the at least one suggested fraud rule for the first issuer is generated based on the segmented consortium transaction data.

5. The method of claim 3, wherein the at least one attribute comprises transaction type.

6. The method of claim 3, wherein the at least one attribute comprises at least one data element defined by ISO 8583.

7. The method of claim 1, wherein the transaction volume category comprises only issuers conducting an average of fewer than 15,000 electronic payment transactions per day.

8. The method of claim 1, wherein the region category comprises only issuers having transaction data in a predetermined country or geographic region, wherein the consortium transaction data comprises only transaction data associated with electronic payment transactions initiated in the predetermined country or geographic region.

9. The method of claim 1, wherein communicating the at least one suggested fraud rule to a first issuer system comprises communicating effectiveness data associated with the at least one suggested fraud rule.

10. The method of claim 1, further comprising filtering, with at least one processor, the consortium transaction data such that the first issuer system does not receive the transaction data associated with the at least one second issuer.

11. A system for automatically generating a suggested fraud rule for an issuer, comprising at least one processor programmed or configured to:
identify a first issuer from a plurality of issuers;
determine a transaction volume category and a region category associated with the first issuer;
determine at least one second issuer from the plurality of issuers, wherein each of the at least one second issuers is associated with the same transaction volume category and region category as the first issuer;
associate the first issuer and the at least one second issuer to form an issuer consortium;
obtain consortium transaction data associated with the issuer consortium, wherein the consortium transaction data comprises transaction data associated with the first issuer and transaction data associated with the at least one second issuer;
generate at least one suggested fraud rule for the first issuer based on the consortium transaction data; and
communicate the at least one suggested fraud rule to a first issuer system associated with the first issuer.

12. The system of claim 11, wherein generating the at least one suggested fraud rule comprises analyzing the consortium transaction data using a machine learning algorithm.

13. The system of claim 11, wherein the at least one processor is further programmed or configured to:
segment the consortium transaction data based on at least one attribute.

14. The system of claim 13, wherein the at least one suggested fraud rule for the first issuer is generated based on the segmented consortium transaction data.

15. The system of claim 13, wherein the at least one attribute comprises transaction type and/or at least one data element defined by ISO 8583.

16. The system of claim 11, wherein the transaction volume category comprises only issuers conducting an average of fewer than 15,000 electronic payment transactions per day.

17. The system of claim 11, wherein the region category comprises only issuers having transaction data in a predetermined country or geographic region, wherein the consortium transaction data comprises only transaction data associated with electronic payment transactions initiated in the predetermined country or geographic region.

18. The system of claim 11, wherein communicating the at least one suggested fraud rule to a first issuer system comprises communicating effectiveness data associated with the at least one suggested fraud rule.

19. The system of claim 11, wherein the at least one processor is further programmed or configured to:
filter the consortium transaction data such that the first issuer system does not receive the transaction data associated with the at least one second issuer.

20. A computer program product for automatically generating a suggested fraud rule for an issuer, the computer program product comprising at least one non-transitory computer-readable medium including one or more instructions that, when executed by at least one processor, cause the at least one processor to:
identify a first issuer from a plurality of issuers;
determine a transaction volume category and a region category associated with the first issuer;
determine at least one second issuer from the plurality of issuers, wherein each of the at least one second issuers is associated with the same transaction volume category and region category as the first issuer;
associate the first issuer and the at least one second issuer to form an issuer consortium;
obtain consortium transaction data associated with the issuer consortium, wherein the consortium transaction data comprises transaction data associated with the first issuer and transaction data associated with the at least one second issuer;
generate at least one suggested fraud rule for the first issuer based on the consortium transaction data; and
communicate the at least one suggested fraud rule to a first issuer system associated with the first issuer.
